(19) United States
(12) Patent Application Publication
(10) Pub. No.: US 2016/0377416 A1
(43) Pub. Date: Dec. 29, 2016

(54) DEVICES AND METHODS FOR ASSESSMENT OF SURFACES

(71) Applicant: 3M INNOVATIVE PROPERTIES COMPANY, Saint Paul, MN (US)

(72) Inventors: Thomas J. Reid, White Bear Lake, MN (US); Elaine M. Yorkgitis, St. Paul, MN (US); Joseph A. Hoffman, Minneapolis, MN (US)

(21) Appl. No.: 15/039,526

(22) PCT Filed: Nov. 20, 2014
(86) PCT No.: PCT/US14/66614

§ 371 Date: May 26, 2016

Related U.S. Application Data
(60) Provisional application No. 61/908,907, filed on Nov. 26, 2013.

(51) Int. Cl. G01B 11/25; G01N 21/88

(52) U.S. Cl. CPC G01B 11/2513; G01N 21/8803; G01N 21/8806; G01N 2201/0621

(57) ABSTRACT

Devices and methods for assessing topography of a reflective surface are provided. The methods comprise directing an arrayed light source onto the reflective surface to produce a reflected light pattern; and observing the reflected light pattern without the use of a computer to detect the presence of one or more topographical features of the reflective surface. The devices comprise an arrayed light source and a portable support operatively connected to the arrayed light source by an adjusting element. The presence of one or more topographical features of the reflective surface to are noted by an observer without the use of a computer. Defects may be discerned by the presence of a swirl in a reflected light pattern.

### TECHNICAL FIELD

This disclosure relates to devices and methods for assessment of surfaces. Specifically, damage of reflective surfaces such as those on automobiles is ascertained visually by use of an arrayed light source, which may be a plurality of point light sources arranged in a desired manner, or which may be a single source of light in combination with a panel having one or more reflective portions or with a patterned mask. The device or apparatus comprises a portable support and the arrayed light source, which may comprise light-emitting diode (LED) lights.

### BACKGROUND

Collision repair shops perform a large number of repair estimates. It is best if these estimates are done quickly but accurately as this pleases the prospective customer, allows the estimator to complete the task in the least amount of time, and allows the customer and estimator to determine the probable cost of the repair as well as the likelihood that the repair can be performed at a cost under the threshold that might prompt a totaling of the vehicle. Particularly troublesome damage assessments include, as one example, the damage from hailstorms, which involves locating a large number of shallow dents in a vehicle body. In addition, minor areas of damage that may occur in an accident or are pre-existing may be more easily overlooked if the estimator focusses on major damages, particularly if minor areas of damage are difficult to detect.

Existing commercial damage assessment lights consist of relatively small illumination systems that may utilize distortion of one or more stripes of light to show interruption of smooth contours in vehicle bodies. Striped (or line array) types of damage assessment lights produce illumination along a largely singular axis, defining approximately only two opposing segments of a dent. Line-array types of detection lights have a similar deficiency in the ability to show the contours (depth and wall slope) of a dent.

Striped damage assessment lights are generally small and cover only a very small portion of the area of a vehicle. They must be moved frequently if they are movable at all. The person doing the assessment must frequently use repetitive head and body movements in order to look at the reflection of the striped lights from a given area, movements that could be tiresome if not injury-inducing to many individuals.

Documentation of damage detected using prior art techniques such as using a striped damage assessment light is often difficult to obtain. Photography of the damaged area is most commonly done in order to provide photographs for an insurance claim file, and these are often transmitted to an insurance company for remote evaluation. When damage is subtle, it generally is first marked with a bright marker after being found using a striped light, and then a photograph is obtained which shows the marked areas as circles or similar indicators of damage, however, in many cases the damage itself is not readily visible in these photographs. And if the vehicle is to be returned to the customer without repair these markings will have to be removed.

Aftermarket collision repair shop estimators sometimes and particularly in the case of subtle or shallow damage by feel rather than by use of any sort of light by running fingertips, fingers, or palms of hands over a surface. This method is slow, and it is subjective. And it provides no visual means for documentation via a photograph, leading inevitably to the marking method described above.

There is a need for fast and easy detection of all damage on a vehicle without the use of a computer. That is, devices are needed that are large enough for an area as large as a door or a hood or conceivably an entire vehicle to be inspected while at the same time offer mobility to conduct an assessment in a variety of locations.

### SUMMARY

Provided are methods of assessing topography of a reflective surface and apparatuses for the same.

In one aspect, provided is a method of assessing topography of a reflective surface, the method comprising: directing an arrayed light source onto the reflective surface to produce a reflected light pattern; and observing the reflected light pattern without the use of a computer to detect the presence of one or more topographical features of the reflective surface.

In another aspect, provided is an apparatus for assessing topography of a reflective surface, the apparatus comprising: an arrayed light source to illuminate the reflective surface thereby producing a reflected light pattern; and a portable support operatively connected to the arrayed light source by an adjusting element; wherein the reflected light pattern is effective to convey the presence of one or more topographical features of the reflective surface to an observer without the use of a computer.

Other features that may be used individually or in combination with respect to any aspect of the invention are as follows.

The arrayed light source may comprise a plurality of point sources that generate an initial light pattern comprising pattern elements, wherein the reflected light pattern comprises the initial light pattern as altered by the presence of one or more topographical features of the reflective surface. The method may further comprising passing light from the plurality of point sources through a lens to shape the light to generate the pattern elements of the initial light pattern.

The arrayed light source may comprise a patterned mask and an off-apparatus light source and the method further comprising positioning the patterned mask in between the off-apparatus light source and the reflective surface, the patterned mask filtering light from the off-apparatus light source to generate the pattern elements of the initial light pattern.

The arrayed light source may comprise a panel having one or more reflective portions and an off-apparatus light source and the method further comprising locating the panel such that light from the off-apparatus light source reflects off the panel to generate the pattern elements of the initial light pattern.

The pattern elements may comprise a repeating pattern of points of light. The initial light pattern may comprise a grid of light, the pattern elements comprising line segments in the grid. The pattern elements may be dispersed in both an X direction and a Y direction. The pattern elements by be equally spaced along the X direction and/or the Y direction. The initial light pattern may comprise a grid of light, the pattern elements may comprise line segments in the grid, the grid may comprise a first set of parallel line segments and a second set of parallel line segments, and the first set of parallel line segments may angularly offset from the second set of parallel line segments by a first angle. The first angle may be in a range from 85 degrees to 95 degrees.

The reflective surface may comprise a work surface treated to enhance its reflectivity. The initial light pattern may comprise pattern elements of a first color and pattern elements of a second color that differs in average wavelength from the first color by at least 25 nm. The array of point sources may be disposed on a light panel, wherein directing the initial light pattern comprises adjusting the position of the light panel to direct the initial light pattern onto a desired portion of the work surface. The patterned mask may be disposed on a light panel, wherein directing the initial light pattern comprises adjusting the position of the light panel to direct the initial light pattern onto a desired portion of the work surface. The point sources may comprise a plurality of light emitting diodes (LEDs) arranged in a grid pattern.

The arrayed light source may illuminate an area of the reflective surface that is at least 8 ft² (7,432 cm²), or at least 12 ft² (11,148 cm²), or at least 16 ft² (14,864 cm²), or even at least 24 ft² (22,296 cm²).

The method may further comprise recording the reflected light pattern with an image recording device. The method may further comprise marking the one or more topographical features after receiving the reflected light pattern. The observing step comprises visually detecting a swirl in the reflected light pattern in the presence of the one or more topographical features. The method may further comprise passing light from the plurality of point sources through a transmissive layer to generate the pattern elements of the initial light pattern.

The portable support may comprise: a frame; and a panel adjustably mounted to the frame and comprising a plurality of point sources disposed that generate an initial light pattern comprising pattern elements from the panel, wherein the point sources are dispersed over an area of the panel that is at least 12 ft² (11,148 cm²).

The panel may be adjustably mounted to the frame by the adjusting element comprising an adjusting element axis, the panel being rotatable about the adjusting element axis to a first panel angular position and a second panel angular position. The panel may be adjustably mounted to the frame by a riser element comprising a riser axis, the panel being adjustable along the riser axis to varying panel heights. The frame may comprise one or more motion elements that permit the apparatus to be moved from a first shop position to a second shop position. The one or more motion elements may be selected from the group consisting of casters, rails, carriages, sliders, and combinations thereof. The apparatus may comprise a lens positioned adjacent the plurality of point sources to shape the light to generate the pattern elements of the initial light pattern. The apparatus may comprise an image recording device positioned to receive and record receiving a reflected light pattern that comprises the initial pattern as altered by reflecting from the work surface. The apparatus may comprise an image processor adapted to assess the reflected light pattern to detect the presence of a first topographical feature on the work surface. The image recording device may be attached to one of the frame or the panel. The image recording device may be remote from the frame and the panel. The reflected light pattern may comprise a swirl in the presence of the one or more topographical features.

The following exemplary embodiments are included within this disclosure, although this disclosure is not limited to these embodiments:

### Embodiment 1

A method of assessing topography of a reflective surface, the method comprising:
directing an arrayed light source onto the reflective surface to produce a reflected light pattern; and
observing the reflected light pattern without the use of a computer to detect the presence of one or more topographical features of the reflective surface.

### Embodiment 2

The method of Embodiment 1 wherein the arrayed light source comprises a plurality of point sources that generate an initial light pattern comprising pattern elements, wherein the reflected light pattern comprises the initial light pattern as altered by the presence of one or more topographical features of the reflective surface.

### Embodiment 3

The method of Embodiment 2 further comprising passing light from the plurality of point sources through a lens to shape the light to generate the pattern elements of the initial light pattern.

### Embodiment 4

The method of Embodiment 1 wherein the arrayed light source comprises a patterned mask and an off-apparatus light source and the method further comprising positioning the patterned mask in between the off-apparatus light source and the reflective surface, the patterned mask filtering light from the off-apparatus light source to generate the pattern elements of the initial light pattern.

### Embodiment 5

The method of Embodiment 1 wherein the arrayed light source comprises a panel having one or more reflective portions and an off-apparatus light source and the method further comprising locating the panel such that light from the off-apparatus light source reflects off the panel to generate the pattern elements of the initial light pattern.

### Embodiment 6

The method of any of Embodiments 2-5 wherein the pattern elements comprise a repeating pattern of points of light.

### Embodiment 7

The method of any of Embodiments 2-5 wherein the initial light pattern comprises a grid of light, the pattern elements comprising line segments in the grid.

### Embodiment 8

The method of any of Embodiments 2-7 wherein the pattern elements are dispersed in both an X direction and a Y direction.

### Embodiment 9

The method of any of Embodiments 2-8 wherein the pattern elements are equally spaced along the X direction and/or the Y direction.

### Embodiment 10

The method of any of Embodiments 7-9 wherein the initial light pattern comprises a grid of light, the pattern elements comprising line segments in the grid, the grid comprising a first set of parallel line segments and a second set of parallel line segments, the first set of parallel line segments being angularly offset from the second set of parallel line segments by a first angle.

### Embodiment 11

The method of Embodiment 10 wherein the first angle is in a range from 85 degrees to 95 degrees.

### Embodiment 12

The method of any of Embodiments 1-11 comprising recording the reflected light pattern with an image recording device.

### Embodiment 13

The method of any of Embodiments 1-12, wherein the reflective surface comprises a work surface treated to enhance its reflectivity.

### Embodiment 14

The method of any of Embodiments 1-13 comprising marking the one or more topographical features after receiving the reflected light pattern.

### Embodiment 15

The method of any of Embodiments 2-14 wherein the initial light pattern comprises pattern elements of a first color and pattern elements of a second color that differs in average wavelength from the first color by at least 25 nm.

### Embodiment 16

The method of any of Embodiments 2-3 wherein the array of point sources is disposed on a light panel, wherein directing the initial light pattern comprises adjusting the position of the light panel to direct the initial light pattern onto a desired portion of the work surface.

### Embodiment 17

The method of Embodiment 4 wherein the patterned mask is disposed on a light panel, wherein directing the initial light pattern comprises adjusting the position of the light panel to direct the initial light pattern onto a desired portion of the work surface.

### Embodiment 18

The method of any of Embodiments 1-17 wherein the arrayed light source illuminates an area of the reflective surface that is at least 8 ft² (7,432 cm²).

### Embodiment 19

The method of Embodiment 18, wherein the area is at least 12 ft² (11,148 cm²).

### Embodiment 20

The method of Embodiment 19, wherein the area is at least 16 ft² (14,864 cm²).

### Embodiment 21

The method of Embodiment 20, wherein the area is at least 24 ft² (22,296 cm²).

### Embodiment 22

The method of any of Embodiments 2-3, 6-16, and 18-21, wherein the point sources comprise a plurality of light emitting diodes (LEDs) arranged in a grid pattern.

### Embodiment 23

The method of any of Embodiments 1-22, wherein the observing step comprises visually detecting a swirl in the reflected light pattern in the presence of the one or more topographical features.

### Embodiment 24

The method of any of Embodiments 2-3 further comprising passing light from the plurality of point sources through a transmissive layer to generate the pattern elements of the initial light pattern.

### Embodiment 25

An apparatus for assessing topography of a reflective surface, the apparatus comprising:
an arrayed light source to illuminate the reflective surface thereby producing a reflected light pattern; and
a portable support operatively connected to the arrayed light source by an adjusting element;
wherein the reflected light pattern is effective to convey the presence of one or more topographical features of the reflective surface to an observer without the use of a computer.

### Embodiment 26

The apparatus of Embodiment 25, wherein the portable support comprises:
a frame; and
a panel adjustably mounted to the frame and comprising a plurality of point sources disposed that generate an initial light pattern comprising pattern elements from the panel, wherein the point sources are dispersed over an area of the panel that is at least 12 ft² (11,148 cm²).

### Embodiment 27

The apparatus of Embodiment 26, wherein the panel is adjustably mounted to the frame by the adjusting element comprising an adjusting element axis, the panel being rotatable about the adjusting element axis to a first panel angular position and a second panel angular position.

### Embodiment 28

The apparatus of any of Embodiments 26-27 wherein the panel is adjustably mounted to the frame by a riser element comprising a riser axis, the panel being adjustable along the riser axis to varying panel heights.

### Embodiment 29

The apparatus of any of Embodiments 26-28 wherein the frame comprises one or more motion elements that permit the apparatus to be moved from a first shop position to a second shop position.

### Embodiment 30

The apparatus of Embodiment 29 wherein the one or more motion elements is selected from the group consisting of casters, rails, carriages, sliders, and combinations thereof.

### Embodiment 31

The apparatus of Embodiment 26 comprising a lens positioned adjacent the plurality of point sources to shape the light to generate the pattern elements of the initial light pattern.

### Embodiment 32

The apparatus of Embodiment 25 wherein the arrayed light source comprises a patterned mask and an off-apparatus light source, the patterned mask filtering light from the off-apparatus light source to generate the pattern elements of the initial light pattern.

### Embodiment 33

The apparatus of Embodiment 25 wherein the arrayed light source comprises a panel having one or more reflective portions and an off-apparatus light wherein light from the off-apparatus light source reflects off the panel to generate the pattern elements of the initial light pattern.

### Embodiment 34

The apparatus of any of Embodiments 26-29 and 31 wherein the pattern elements comprise a repeating pattern of points of light.

### Embodiment 35

The apparatus of any of Embodiments 26-29, 31, and 34 wherein the initial light pattern comprises a grid of light, the pattern elements comprising line segments in the grid.

### Embodiment 36

The apparatus of any of Embodiments 26-29, 31, and 34-35 wherein the pattern elements are dispersed in both an X direction and a Y direction.

### Embodiment 37

The apparatus of Embodiment 36 wherein the pattern elements are equally spaced along the X direction and/or the Y direction.

### Embodiment 38

The apparatus of any of Embodiments 35-37 wherein the initial light pattern comprises a grid of light, the pattern elements comprising line segments in the grid, the grid comprising a first set of parallel line segments and a second set of parallel line segments, the first set of parallel line segments being angularly offset from the second set of parallel line segments by a first angle.

### Embodiment 39

The apparatus of Embodiment 38 wherein the first angle is in a range from 85 degrees to 95 degrees.

### Embodiment 40

The apparatus of any of Embodiments 25-39 comprising an image recording device positioned to receive and record receiving a reflected light pattern that comprises the initial pattern as altered by reflecting from the work surface.

### Embodiment 41

The apparatus of Embodiment 40 comprising an image processor adapted to assess the reflected light pattern to detect the presence of a first topographical feature on the work surface.

### Embodiment 42

The apparatus of any of Embodiments 40-41 wherein the image recording device is attached to one of the frame or the panel.

### Embodiment 43

The apparatus of any of Embodiments 40-41 wherein the image recording device is remote from the frame and the panel.

### Embodiment 44

The apparatus of any of Embodiments 26-29, 31, and 34-39 wherein the initial light pattern comprises pattern elements of a first color and pattern elements of a second color that differs in average wavelength from the first color by at least 25 nm.

### Embodiment 45

The apparatus of any of Embodiments 26-29, 31, and 34-39, wherein the point sources comprise a plurality of light emitting diodes (LEDs) arranged in a grid pattern.

### Embodiment 46

The apparatus of any of Embodiments 25-45, wherein the reflected light pattern comprises a swirl in the presence of the one or more topographical features.

These and other aspects of the invention are described in the detailed description below. In no event should the above summary be construed as a limitation on the claimed subject matter.

### BRIEF DESCRIPTION OF THE DRAWINGS

The accompanying drawings are included to provide a further understanding of the invention described herein and are incorporated in and constitute a part of this specification. The drawings illustrate exemplary embodiments. Certain features may be better understood by reference to the following detailed description when considered in connection with the accompanying drawings, in which like reference numerals designate like parts throughout the figures thereof, and wherein:

FIG. 1 is a schematic of an exemplary method of detecting topographical features, e.g., defects;

FIG. 2 is a schematic of an exemplary device for detecting topographical features;

FIG. 3 is a photograph where damage to a reflective surface was visible by the presence of swirls by using an apparatus according to the invention;

FIGS. 4a-4i provide a series of photographs where the reflective surface of FIG. 3 was viewed using an array of comparative observation lights;

FIG. 5 is a photograph where damage to another reflective surface was visible by the presence of swirls by using an apparatus according to the invention;

FIGS. 6a-6i provide a series of photographs where the reflective surface of FIG. 5 was viewed using an array of comparative observation lights;

FIG. 7a is a photograph of a matte test surface; FIG. 7b is the test surface of FIG. 7a upon application of a thin film of isopropanol to a portion of the test surface; FIG. 7c is the test surface of FIG. 7b upon application of a thin film of isopropanol to the remainder of the test surface;

FIG. 8a is a photograph of another matte test surface; FIG. 8b is the test surface of FIG. 8a upon application of a glossy, clear film; and

FIGS. 9a-9c provide a series of photographs where a test surface is made progressively more glossy as viewed using a small arrayed apparatus according to the invention; FIG. 9d is a photograph of the test surface of FIG. 9c using as viewed using a large arrayed apparatus according to the invention.

The figures are not necessarily to scale. Like numbers used in the figures refer to like components. It will be understood, however, that the use of a number to refer to a component in a given figure is not intended to limit the component in another figure labeled with the same number.

### DETAILED DESCRIPTION

Provided are devices and methods for assessing damage to a reflective surface, where the devices comprise an arrayed light source to illuminate the reflective surface thereby producing a reflected arrayed light pattern, and a portable support operatively connected to the arrayed light source by an adjusting element. A reflected arrayed light pattern includes a swirl is an indicator that there is a topographical feature, such as a defect or a designed-in contour, in the surface. For example, assessing damage to a motor vehicle uses an arrayed light source, e.g., a matrix (or point array) of lights, such as LED (light-emitting diode) lights, on a flat panel that illuminate the surface produces a pattern of light in the reflection from the vehicle surface that provides a visual indication of damage thereby allowing a collision repair estimator fast identification of the location of damaged areas and the extent of damage by virtue of distinct patterns seen on the surface. Damaged areas and especially small subtly damaged areas that are ordinarily very difficult to detect are clearly differentiated from undamaged areas by the appearance of characteristic swirls that highlight damaged areas in a manner unlike any other known method. Using this method to assess damage is fast, requires minimal training, and is adaptable to many environments. Such devices would access power sources and connectors associated with light sources, such as an LED light matrix. Useful additions to the method and the apparatus used to carry out the method can include 1) a camera, which photographs easily to record the image, 2) treatments to render a non-reflective surface temporarily reflective, 3) markers to temporarily mark damaged areas for later reference or inclusion in photographs, 4) protective coverings for the arrayed light source which may be permanent or disposable and may provide an easy-to-clean surface and which may also or instead enhance the light source's utility by their optical qualities, 5) suitable mechanical supports or racks (with parts including optionally frames or racks, clamps or other fasteners, pulleys, rolling wheels, and the like) that can be moved and adjusted and positioned in such a way that the sides, front, back, and top of a vehicle located above the floor can be examined using the described method and, optionally, allow the examination to be done in various areas of a collision repair facility including areas outside the body shop, that is, in the outdoor environment or in another building of the same facility, made possible in part by the low weight and slim profile of the LED light matrix, 6) a second interpenetrating array of LED lights of a different color which may be powered on separately or simultaneously with the first, and 7) a (removable) colored filter over one or more LED lights. Other uses of the described invention will be exemplified.

The devices provided herein are superior to prior art striped lights in that they provide a full area assessment of the damage with information about, in most cases, the full perimeter of the damaged area, its depth, and its wall slope. In addition, the methods are be practiced with an arrayed light source that is large enough for an area as large as a door or a hood or conceivably an entire vehicle to be inspected and assessed at once with no need for awkward movements or other inconveniences. Such devices are portable and may be used at any location, indoors or outdoors. A large sized-device (for example, 4 feet by 8 feet) generally completely blocks out extraneous reflections from adjacent areas around the vehicle that are normally reflected in the paint (leaves on the ground, another vehicle reflected in the paint, a nearby tree, etc.). Also, the methods provide quickly and easily the means of detecting damage visually and taking a photograph which clearly indicates the location and extent of the damage as shown by the detection method.

Reference to an “arrayed light source” means light provided by one or more light sources, where points of light are arranged in an X-Y coordinate system. The light sources can be any suitable source known by those skilled in the art, such as light-emitting diodes (LEDs), fluorescent light bulbs, incandescent light bulbs, the sun and the like. The arrayed light source is preferably a plurality point light sources that may be arranged symmetrically in the X and/or Y coordinates. An exemplary arrayed light source is based on one or more flexible LED mats, obtained under the trade designation “3M FLEXIBLE LIGHT MAT, PRODUCT No. 3635-1030” from 3M Company, St. Paul, Minn. It is also contemplated that an arrayed light source may be a single source of light, e.g., an off-apparatus light source such as ambient light or the sun, in combination with a panel having one or more reflective portions and a having pattern on a background. For example, such a panel may contain an array of white or light-colored dots on a reflective background of black or other dark color that has a high contrast with the white or light-colored dots. Another panel may have a reflective white or light-colored background with an array of black other dark color that has a high contrast with the white or light-colored background. Yet another panel may have a reflective background made from a film, such as 3M™ Scotchlite™ Reflective Films with an array of dots that contrast with the film. It is also contemplated that an arrayed light source may be a single source of light, e.g., an off-apparatus light source, in combination with a patterned mask to produce points of light or in combination with a panel that contains an array of white or light-colored dots on a background of black or other dark color that has a high contrast with the white or light-colored dots. A patterned mask may be a sheet with a pattern of perforated holes. Reference to “point source” means individual, discontinuous sources of light, such as provided by an LED.

A “reflected light pattern” means the pattern of light reflected back to an observer's eye as provided by points of light arranged in an X-Y coordinate system.

Reference to “swirl” means having at least one portion that is a circular shape, which can be continuous or discontinuous and further possibly contain concentric circular shapes. For detecting defects, the circular shape may be entirely present or just a portion may be visually discernible. Within the swirl, there can be other shapes that are continuous or discontinuous.

Reference to “initial light pattern” means a light pattern that is emitted from the arrayed light source. The initial light pattern is made-up of pattern elements. On receipt onto a flat surface, the pattern elements correspond to pattern of the arrayed light source. In the presence of a non-flat surface having topographical features, the pattern elements are altered and a swirl is reflected back in a reflected light pattern.

Reference to “without the use of a computer” means that interpreting a reflected light pattern can be done without the need to convey the reflected light pattern to a device containing a microprocessor in order to run an algorithm on the reflected light pattern for analysis. In contrast, use of a computer is demonstrated by an inspection system of bumpers, as shown in US2007/0206182, which requires the use of an algorithm to interpret reflected light. That is, in US2007/0206182 the method comprises irradiating an irradiation light having a predetermined pattern on the inspection target surface; imaging the surface irradiated with the irradiation light; and inspecting the inspection target surface based on an obtained image of the inspection target surface. Rather than direct visual inspection for defects by a worker, the worker relies on an image as shown on an inspection result projector resulting from an image processing device.

A device is “effective to convey the presence of one or more topographical features” when its light source is able to provide a reflected light pattern whose features are adequately noticeable to be interpreted by observation. Such devices may deliver points of lights in a density that accounts for the size of features or defects being sought. For example, the spacing of points of lights generally should not allow for areas of no light that are bigger than the defects. Such devices also may offer mobility so that the points of light are easily adjusted to examine and scan surfaces from many angles.

“Reflective surface” means a surface whose finish reflects light from the arrayed light source adequately to product a reflected light pattern. It is expected that the exterior finish of commercially available automobiles have a reflective surface, but usually interior surfaces without clear coat would not have a reflective surface.

If a surface to be inspected is not sufficiently reflective, various ways can be used to render the surface reflective enough to facilitate use of the arrayed light source, for example an LED light array, to assess surface/topographical features, for example, damage to a vehicle. In some instances, sufficient reflectivity may be present for real-time viewing but may need to be enhanced in order to document the condition of the surface of interest via photography. Within the automotive field, surfaces that may not be sufficiently reflective may include bare metal, unpainted thermoplastic olefin (TPO) bumpers, plastic moldings, primed surfaces, sealed surfaces, and painted matte finishes. General ways of making the surface more reflective by adding a reflective layer could include liquids, coatings, and films. For each of these three types, many options exist for making a reflective surface with a goal of achieving a clear reflected image of the LED light array without doing significant harm to the surface of interest. In some cases, the reflective layer in combination with the LED light array may assist in a forensic investigation, accident reconstruction, design improvement, material selection process, or any other study of the way in which the object or surface of interest interacted with a similar object and surface or a dissimilar object or surface.

A suitable liquid preferably will not harm the surface of interest by negatively interacting with it through permeation or dissolution that might stain, wrinkle, remove, or otherwise significantly disturb the surface. The liquid also will remain present on the surface of interest long enough for inspection to occur and, in some cases, long enough for photographs to be taken or other documentation to be completed. Sufficient time is entirely dependent on the user's needs, and it may range from at least about a minute up to many hours. After an optional initial equilibrating period, the liquid will not contain bubbles or other defects which interfere or compete with the reflected image of the LED light array which is made visible through its use. In one respect, the liquid should form a smooth mirror-like surface which can clearly reflect the image of the LED light array. Subject to the limitations above, those liquids which would make a surface more reflective will to some extent depend on the subject of interest and its material composition as a given liquid may be acceptable for use on one substrate or surface finish but not another. Such liquids could include water, ethanol, isopropanol, paint thinner, petroleum ether, mineral spirits, poly(ethylene glycol) of relatively low molecular weight (below about 3000 g/mol), ethylene glycol, octyl stearate, or virtually any other liquid which is capable of being easily sprayed, brushed, wiped, dipped, rolled, or otherwise spread onto or coated onto the surface of interest and render it sufficiently reflective long enough to enable use of the LED light array as needed. The chemistry of the liquid may be aqueous, organic, inorganic, or ionic. Liquids may be combined, for example, water may be combined with one or more alcohols, or poly(ethylene glycol) may be dissolved in water. If the surface is not wettable by a given liquid, it may be necessary to add a surfactant to the liquid to lower surface energy or to add a compatible fluid to the liquid which would lower its surface energy sufficiently to allow it to wet the surface of interest. In some cases it may be necessary to modify the rheology of the liquid with an organic or inorganic rheology modifier so that it spreads and levels adequately on the surface of interest or so that it does not flow on a vertical surface. The liquid need not be transparent and colorless but preferably it would be uniform in all aspects of its appearance. Preferably such liquids will evaporate without leaving any residue behind or will be able to be wiped away without leaving any residue. In other cases they may need to be removed with a cleaning agent such as a detergent solution, soapy water, or a citrus cleaner, or will have to be removed using an abrasive tool in conjunction with liquid or solid abrasive materials. In some cases, the liquid may not need to be removed.

Formation of a reflective layer may involve a two-step process of first applying a chemical or physical treatment that renders a surface water-wettable and then applying a secondary layer. The first treatment by itself would not improve the reflectivity of the surface of interest. An example of a chemical treatment is application of an acidic silica nanoparticle coating, two types of which are described in WO2010/114700A1 and WO2010/042671A1. These nanoparticle coatings create surfaces that are hydrophilic and highly water-wettable. After application and drying of the nanoparticle coating, the coating can be sprayed with a secondary layer such as water to provide sufficient reflectivity for practice of the invention herein. Examples of corresponding physical treatment would be flame or corona treatments of the surface of interest which oxidize the surface of interest and increases its hydrophilicity and water-wettability.

The surface of interest may also be rendered reflective by being coated with a film-forming liquid which hardens to produce an adherent coating. Film-forming liquids that are suitable could include a glossy latex paint, a glossy latex-based adhesive, an aqueous solution of poly(vinyl alcohol) or another water-soluble polymer, an aqueous solution of cornstarch or another natural water-soluble polymer, a polyurethane dispersion that may in some cases be diluted with water, nail polish or similar high gloss hydrocarbon-based solutions of acrylate polymers, a thermosetting composition such as may be based on multi-functional epoxy or acrylate resins, and so on. In addition to those materials already named, other polymeric materials may be useful in suitable coatings including poly(vinyl acetate) and its copolymers including poly(vinyl chloride-co-vinyl acetate), poly(acrylamide), poly(acrylic acid), poly(methacrylic acid), poly(2-vinyl pyridine), poly(-vinyl pyridine), poly(-glycerol methacrylate), poly(ethylene-co-acrylic acid), poly(N-vinylpyrrolidone), polyethyleneimine, poly(methyl methacrylate and its copolymers as well as miscellaneous acrylic ester polymers and copolymers such as those based on poly(butyl acrylate) or poly(ethyl acrylate), polyethers, epoxy resins, styrene-butadiene copolymers including methacrylate-styrene-butadiene copolymers, alkyd resins, and any combination thereof, and virtually any other polymeric material prepared in a form which may be coated onto a surface, set up, harden, and, optionally, cure to produce an adequately adhered and sufficiently light-reflective layer on the surface of interest. The coating may be available as conventionally considered to be more of an adhesive than a coating but may still fulfill the requirements of a coating for the practice of the inventive method. The coating may contain any number of additives typical of coatings including co-solvents, propellants, curing agents, catalysts, colorants, dyes, pigments, fillers, surfactants, defoamers, leveling agents, rheology modifiers, flexibilizers, tougheners, impact modifiers, biocides, anti-oxidants, and stabilizers against heat and/or light.

Additional guidance in chemistry of such coatings may be found in the volume Protective Coatings by Clive H. Hare, Technology Publishing Company, Pittsburgh, Pa. (1994) as well as the volume Polymer Materials: An Introduction for Technologists and Scientists, Christopher Hall, Halsted Press, N.Y. (1989). The film may have a specific color via incorporation of dyes, pigments, or other colorants that enhances the contrast ratio of the reflection of the LED light array. Once the solvent carrier, which may be water-based or hydrocarbon-based, in these film-forming liquids has evaporated, the coating left behind will remain sufficiently reflective, allowing additional damage assessment with the LED array at a future time. Solventless coatings may also be suitable. The coating may set via evaporation of the solvent carrier alone, through coalescence of solid particles or association of individual polymer molecules through entanglement and similar processes, through chemical and/or physical cure which generally occurs through crosslinking, or through physical cure which occurs through association of one or more similar species to form one or more matrices. In one respect, the liquid should form a smooth mirror-like surface which can clearly reflect the image of the LED light array. The coating formed through the use of a film-forming liquid may be removable by peeling or chipping or through the use of liquid or solid abrasion. Removal of the coating may be aided by the use of applied heat or cold. In some cases, the coating may not be removable without damaging the substrate or surface finish. The coating may be left in place whether or not it can be removed without damaging the substrate or surface finish.

The surface of interest should be positioned in such a way that an excess of liquid or film-forming liquid would not obscure the features of interest. Likewise, the thickness of the reflective layer applied by use of either liquids or coatings as described above must be low enough that it does not fill or bridge the defects or other features of interest, thereby making them undetectable by the LED light array. Depending on the roughness of the existing surface finish, multiple applications of the film-forming liquid may be necessary in order to form a sufficiently reflective surface. Another purpose of the LED light array thus may be the determination of the thickness of an overcoating and the method of its application which does effectively obscure a defect or feature.

The reflectivity of the surface may also be enhanced by the attachment of a pre-formed plastic film such as a cling film (e. g., 3M™ FVS110S Vinyl Static Cling Film or 3M 7717SW PET Smooth Cling Film), a high gloss protective film (e. g., 3M™ PPF™) an adhesive tape (e.g., 3M™ Packaging Tape), or any similar material able to adhere via adhesive forces, capillarity forces, static attraction, ionic attraction, van der Waal's forces, or other means in order to closely fit to the surface of interest, allowing the LED light array to distinguish the features of interest in that surface. The pre-formed thermoplastic film preferably will substantially fully wet out the surface of interest although it may be useful even without substantially full wetting. Wetting may be enhanced through use of wiping or spraying with an aqueous detergent solution and use of sponge or squeegee or similar tool such as is often recommended for application of such films. The plastic film may be readily removable or may be left in place. Polymeric materials which may be useful film materials would include polyethylene and its copolymers, polypropylene and its copolymers, poly(vinyl chloride) including plasticized PVC, poly(vinylidene chloride) and its copolymers, poly(methyl methacrylate) and its copolymers, polystyrene and its copolymers, poly(ethylene terephthalate), glycol-modified poly(ethylene terephthalate) generally known as PETG, poly(butylene terephthalate), polycarbonate, cellulose acetate, polyimide, poly(vinyl acetate) and its copolymers, poly(tetrafluoroethylene), poly(vinylidene fluoride), poly(vinylidene fluoride-co-hexafluoropropylene), poly(chlorotrifluoroethylene), poly(vinylidene fluoride-co-chlorotrifluoroethylene), and poly(tetrafluoroethylene-co-hexafluoropropylene), poly(ethylene naphthalate), ethylene-vinyl acetate copolymers, polyamides, poly(ether ether ketone), polyethers of molecular weight greater than about 3000 g/mol, flexible epoxy-based polymers, polyurethanes, and virtually any other polymeric material which may be made in film form via extrusion or casting processes or some combination of such processes such that it has a sufficiently reflective surface and sufficient flexibility to conform to the surface of interest. Suitable films also may be made from biodegradable or compostable polymeric materials. The film may have a specific color via incorporation of dyes, pigments, or other colorants which enhances the contrast ratio of the reflection of the LED light array.

Before describing several exemplary embodiments of the invention, it is to be understood that the invention is not limited to the details of construction or process steps set forth in the following description. The invention is capable of other embodiments and of being practiced or being carried out in various ways.

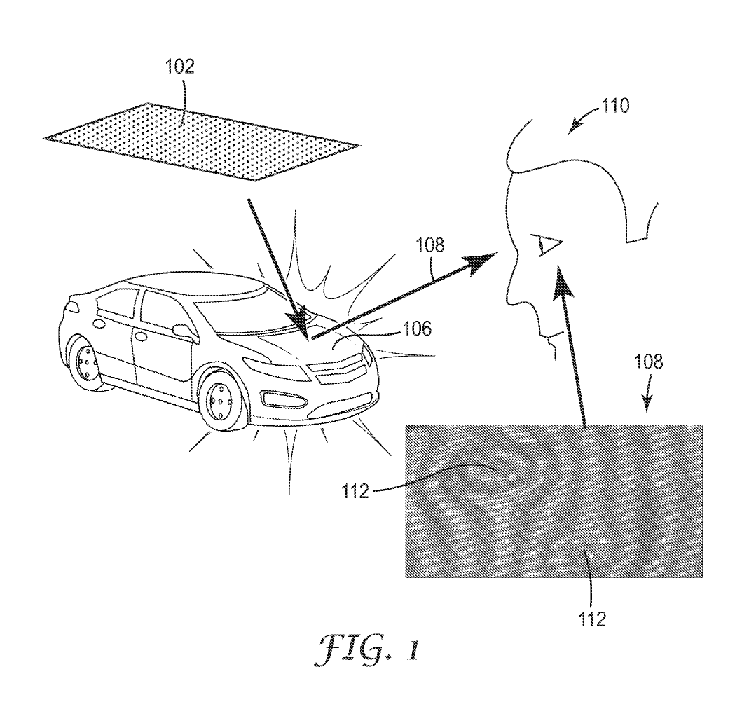

Turning to FIG. 1, a method of visually inspecting the topography of a reflective surface 106 includes illuminating the reflective surface with an arrayed light source 102 to produce a reflected arrayed light pattern 108; and visually observing 110 the reflected arrayed light pattern 108 to detect the presence of one or more topographical features of the reflective surface. The arrayed light pattern 108 shows one or more swirls 112 to denote the presence of a topographical feature on the reflective surface. The method may be done without the use of a computer. Light from the arrayed light source may pass through a lens or a transmissive layer before reaching the reflective surface.

While the unique light effects of the LED light matrix that are described here would be of value in the estimating step of collision repair, it is anticipated that they could also be used to advantage in body work, paint inspection, and detailing. An arrayed light source formed by a plurality of LED point sources is may also useful as a general illumination system that provides bright, largely shadowless, dimmable, energy-efficient lighting for various uses in the collision shop environment. If desired, a diffuser could be used with the LED light matrix when it is not being used for work which makes use of the unique light effects described herein.

In addition to its use in damage assessment of vehicles and general lighting in a collision repair business, the apparatuses disclosed herein may be useful for damage assessment of objects and materials in many other arenas including aircraft, appliances, furniture, glass, mirrors, ceramics, architectural walls, plastic sheeting, metal-coated plastics, book covers, and pressed or rolled (coated) metals. Additionally, apparatuses could be used for assessment of distortion and defect detection in web-based materials at point of manufacture or resale such as extruded polyester, polyolefin, or vinyl films as well as coated web-based materials such as graphic arts products, traffic control sheeting, and the like.

Moreover, the methods disclosed herein are not limited to detection of damage or defects. Virtually any reflective surface or surface which may be made reflective permanently or temporarily may have its surface topology examined via this invention. Objects or materials of interest in this regard could include art works in various media, fabrics that have sheen, molded articles, and so on. The same article or material that may be originally inspected for quality assessment may on another occasion be inspected because of suspected damage or deterioration of quality.

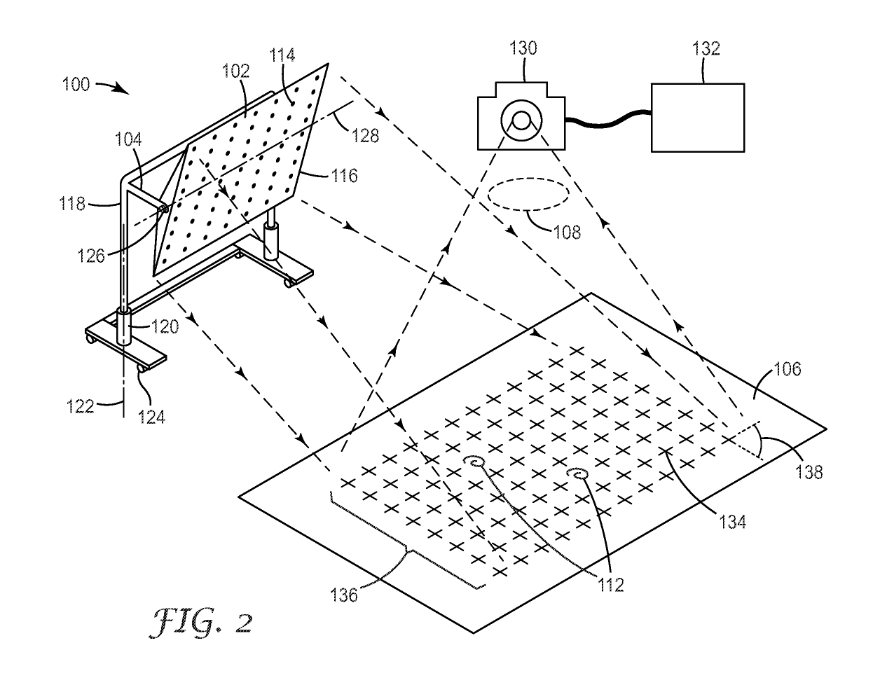

In FIG. 2, an apparatus 100 for assessment of the reflective surface 106 is shown, the apparatus 100 comprising an arrayed light source 102 and a portable support 104 operatively connected to the arrayed light source 102 by an adjusting element 126 having an adjusting element axis 128. An exemplary adjusting element is a hinge. Specifically, the arrayed light source 102 comprises a plurality of point sources 114 and a panel 116 that is pivotable about the adjusting element axis 128. The portable support 104 comprises a frame 118 and/or a riser element 120 that has a riser axis 122. Optional motion elements 124 can be affixed to the portable support. An initial light pattern 136 is emitted from the plurality of point sources 114 and pattern elements 134 are received onto the surface. This initial pattern is one that becomes altered upon reflection by a non-flat reflective surface 106. Any topographical feature present on the surface will alter the initial light pattern and produce a swirl 112 that is detectable visually without the aid of a processor of a computer.

It may be desirable to utilize an arrayed light source that emits a grid of light comprising a first set of parallel line segments and a second set of parallel line segments, the first set of parallel line segments being angularly offset from the second set of parallel line segments by a first angle 138. An exemplary angle is in the range of 85 to 95 degrees.

An image recording device 130, such as a camera, and an optional image processor 132 may be part of the apparatus to provide a way to capture what an observer is seeing.

The arrayed light source provides points of light in an X-Y coordinate system. The arrayed light source may be a plurality of point light sources arranged in a desired manner, or which may be a single source of light in combination with a panel having one or more reflective portions or with a patterned mask. The initial light pattern emitted from the arrayed light source, that is, from individual point sources, from the panel having one or more reflective portions, or from light after any use of a lens or transmissive layer or patterned mask, comprises pattern elements. The pattern elements may be in a repeating pattern. The initial light pattern may be a grid of light and the pattern element may be line segments in the grid. The pattern elements are typically dispersed in both an X direction and a Y direction. Depending on the receiving surface, the patter elements may be equally spaced along the X direction and the Y direction.

It may be desirable to utilize points of light of more than one color. For example, the initial light pattern may comprise pattern elements of a first color and pattern elements of a second color that differs in average wavelength from the first color by at least 25 nm. For example, a first set of LEDs may be white and a second set may be blue. It may also be desirable to use a reflective panel or patterned mask with a single light source or with a plurality of light sources. A reflective panel may be designed as needed with colors and reflective portions to meet desired applications.

### EXAMPLES

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Mo., or may be synthesized by conventional methods.

The following abbreviations are used to describe the examples:
A: amp
cm: centimeter
AC: alternating current
cd: candela
DC: direct current
ft: foot
LED: light emitting diode
m: meter
mil: 10⁻³ inches
m: micrometer
mA: milliamp
mW: milliwatt
in²: square inch
cm²: square centimeter
V: Volt
W: Watt

### Damage Assessment Lights

### Large Array Light

A 4 by 8 ft. (1.22 by 2.44 m) damage assessment light was constructed as follows. The liner was removed from a 12 by 24 inch (30.48 by 60.96 cm) flexible LED mat, having a 7 by 14 array of equally spaced LEDs, obtained under the trade designation “3M FLEXIBLE LIGHT MAT, PRODUCT No. 3635-1030” from 3M Company, St. Paul, Minn. The LED mat was then laminated onto the upper left corner of a 3/16-inch by 4 ft. by 8 ft. (4.8 mm by 1.22 by 2.44 m) white wood fiber veneer bonded polystyrene foamcore board, obtained under the trade designation “GATORFOAM” from Foamboard Source.com, Inc., West Babylon, N.Y. A second flexible LED mat was then laminated onto the foamcore board adjacent to the first LED mat. This process was repeated with another fourteen flexible LED mats, until the entire foamcore board was covered, resulting in a damage assessment panel comprising a 28 by 56 array of LEDs. The LEDs used in the flexible mats were 30 mA white LED's, having a luminous intensity of 3.3 cd, obtained under the trade designation “NSSW064A” from Nichia Corporation, Tokushima, Japan. The sixteen flexible LED mats were wired in series and each pair of mats independently controlled at constant current by means of a 100 W/24v/4.1 A, 0-10V analog dimming LED driver, model “LED ELECTRONIC DRIVER, LEDINTA0024V41DLO”, obtained from Philips Advance, Rosemount, Ill.

### Small Array Light

A smaller, portable, damage assessment light was constructed from an 8 by 8 LED array on a 22 by 22 cm rigid plastic support, part no. “FPLS225U400 2323” obtained from Samsung Electronics, Co. Ltd., Suwon, South Korea. The 65 mA white LEDs had a luminous intensity of 8 cd, and were controlled at constant current by means of a 26.5v/0.387A LED driver.

### Comparative Light

For comparative purposes, observations were made under a 4 by 6 array of paired, ceiling mounted, fluorescent lights. Each pair consisted of 4 ft (121.92 cm) 40 W fluorescent bulbs, 4 inches (10.16 cm) apart, covered by a diffusing lens. Four pairs of lights were aligned end to end, 6 inches (15.24 cm) apart, in rows of 6 pairs spaced 4 ft (121.92 cm) apart. Distance between the lights and the test panels was approximately 2.5 meters.

### EXAMPLE 1

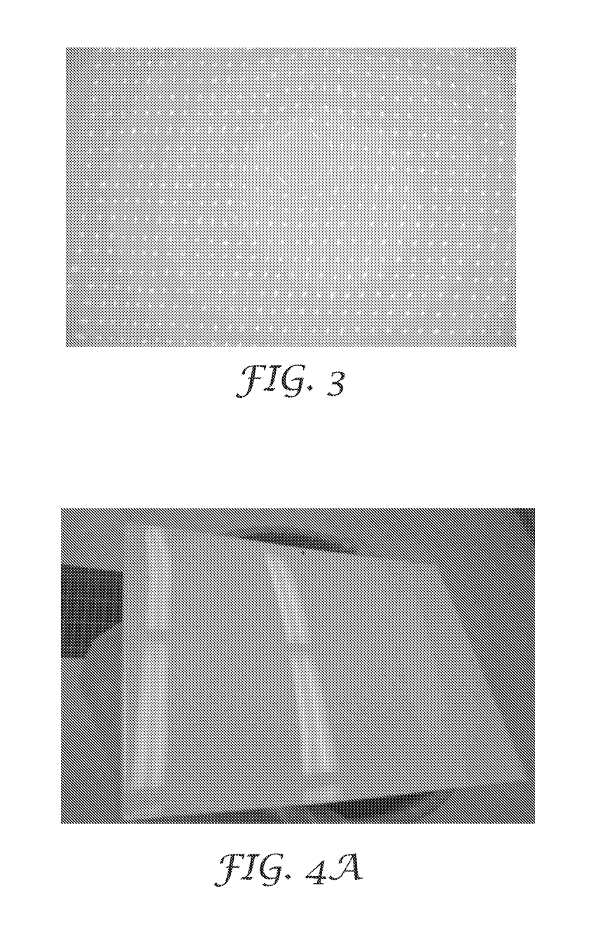

An 18×24 inch (45.72 by 60.96 cm) e-coated- and primer-coated aluminum test panel, having a white pigmented top coat, type “DuPONT IMRON 5000 NO202H”, was obtained from ACT Laboratories, Inc., Hillsdale, Mich. Two small dents of different sizes were stamped into the test panel using a hammer while the panel was covered with a folded microfiber towel. The test panel was then inspected using the large array damage assessment light at an oblique angle and a distance of approximately 1.3 meters. The damaged areas were clearly visible, as demonstrated in FIG. 3. Providing the observer could see the reflection of the LED array, the two damaged areas were always clearly visible, irrespective of the observer's position.

### COMPARATIVE A

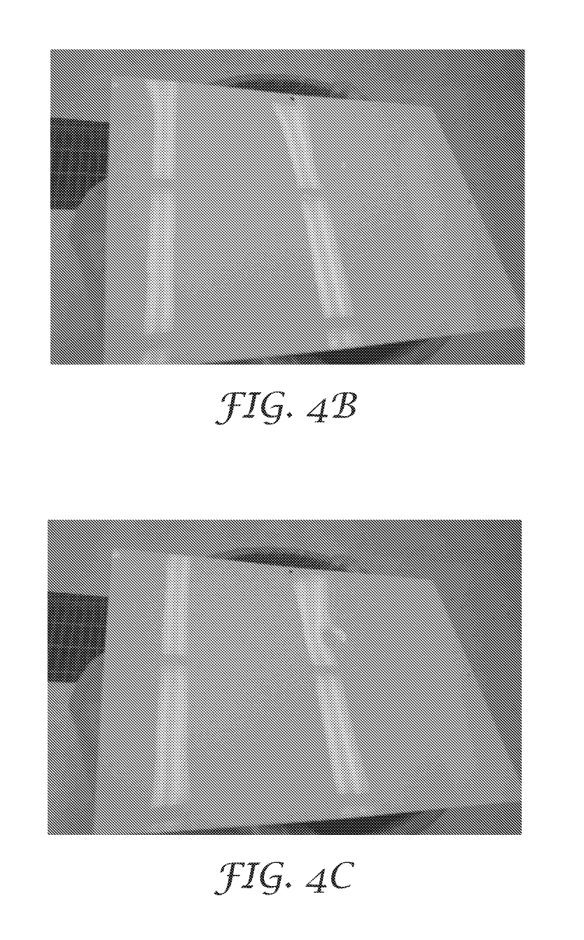

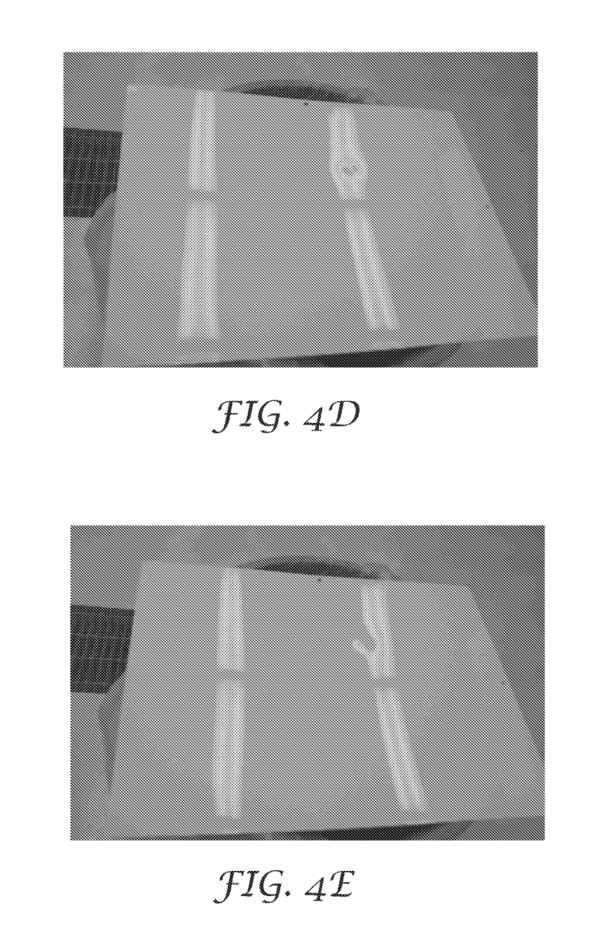

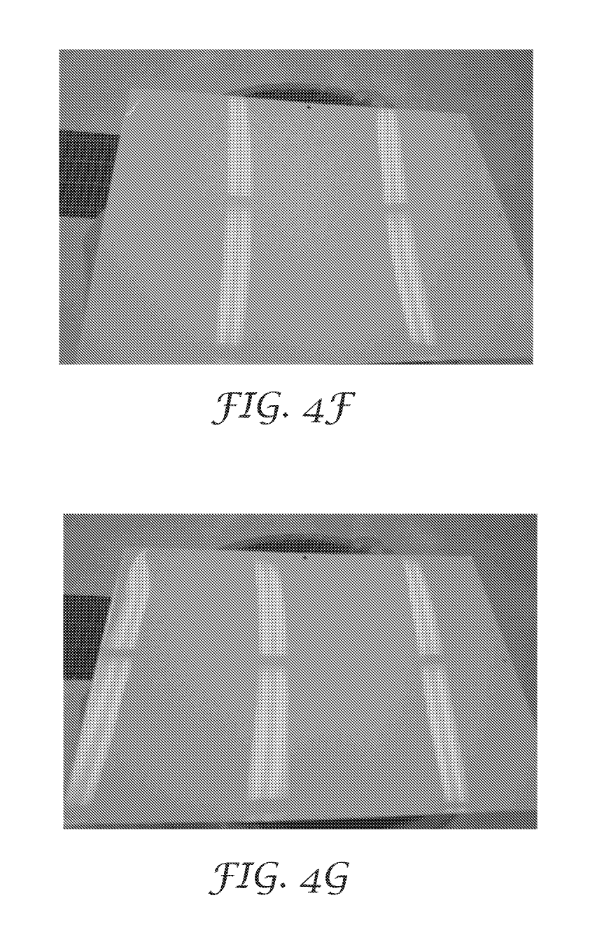

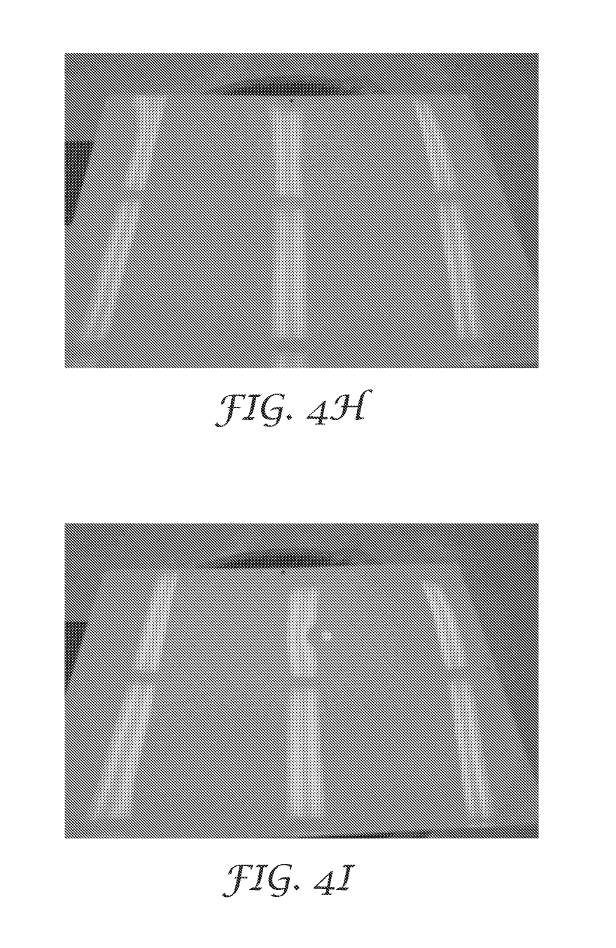

The damaged white test panel was then positioned approximately horizontally under the 4 by 6 array of Comparative observation lights at a distance of approximately 2.5 meters. The ability to observe one or both damaged areas of the test panel was dependent on the observer's position relative to the reflection of the overhead fluorescent lights, as demonstrated by FIGS. 4a-4i.

### EXAMPLE 2

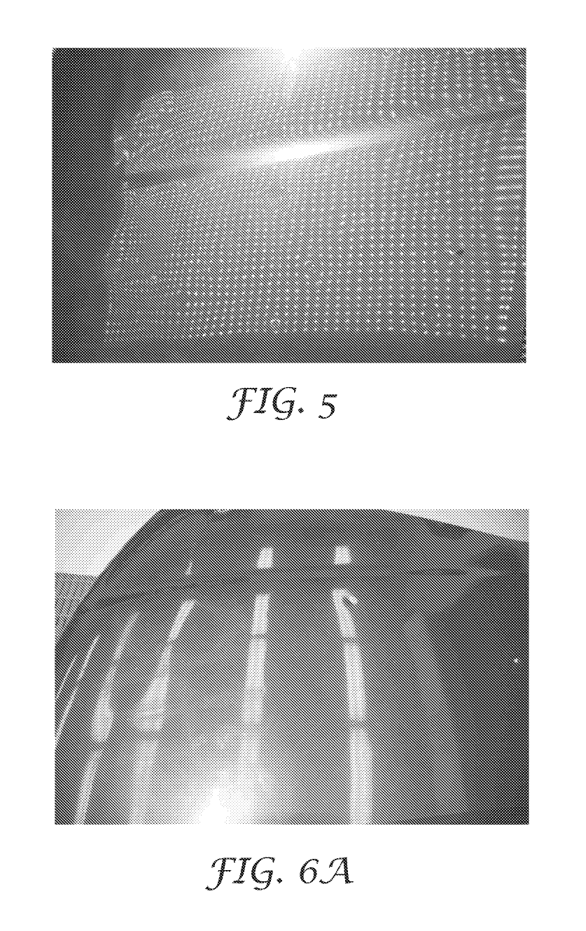

A dark blue-green vehicle hood having several small dents was inspected at an oblique angle under the large array damage assessment light at distance of approximately 1.3 meters. The damaged areas were clearly visible, as demonstrated in FIG. 5. Providing the observer could see the reflection of the LED array, the two damaged areas were always clearly visible, irrespective of the observer's position.

### COMPARATIVE B

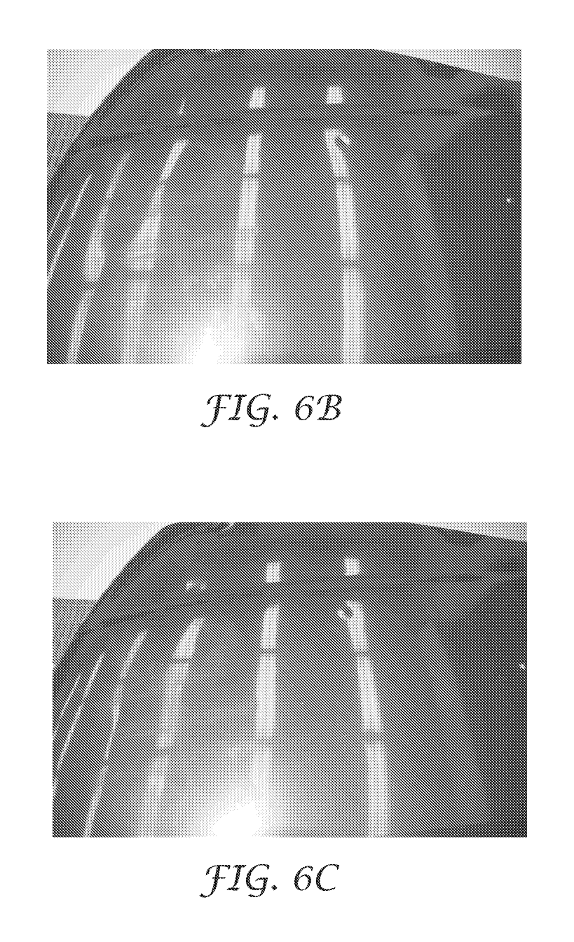

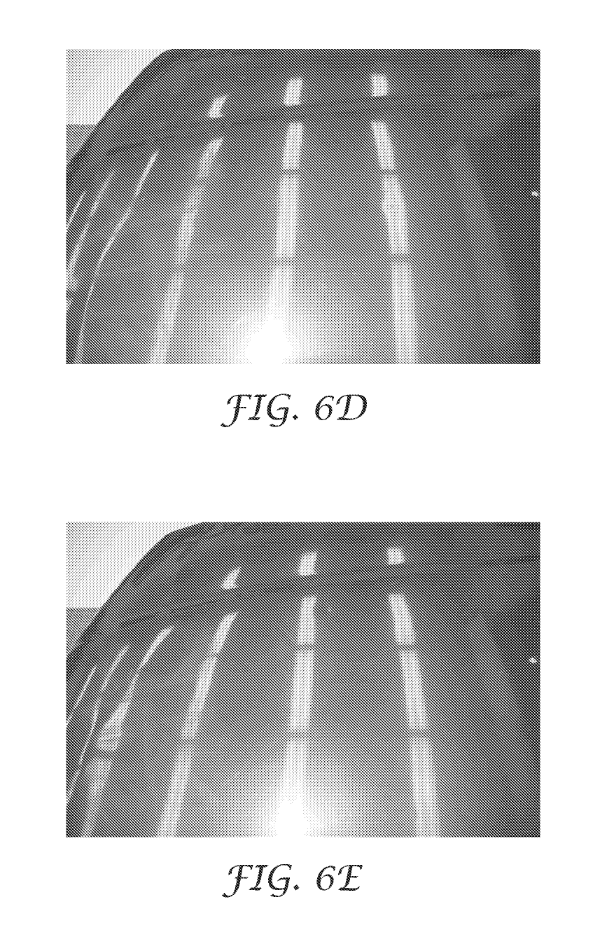

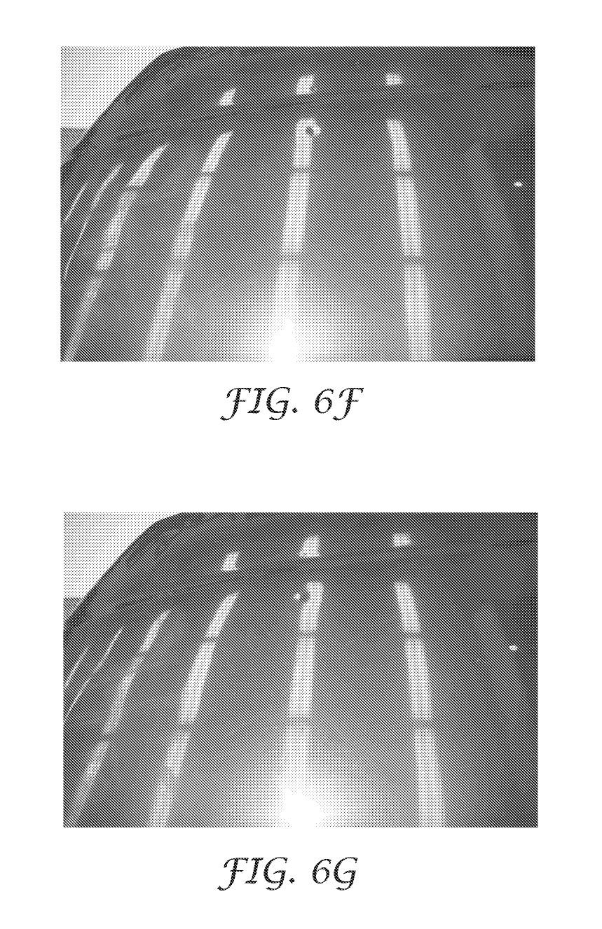

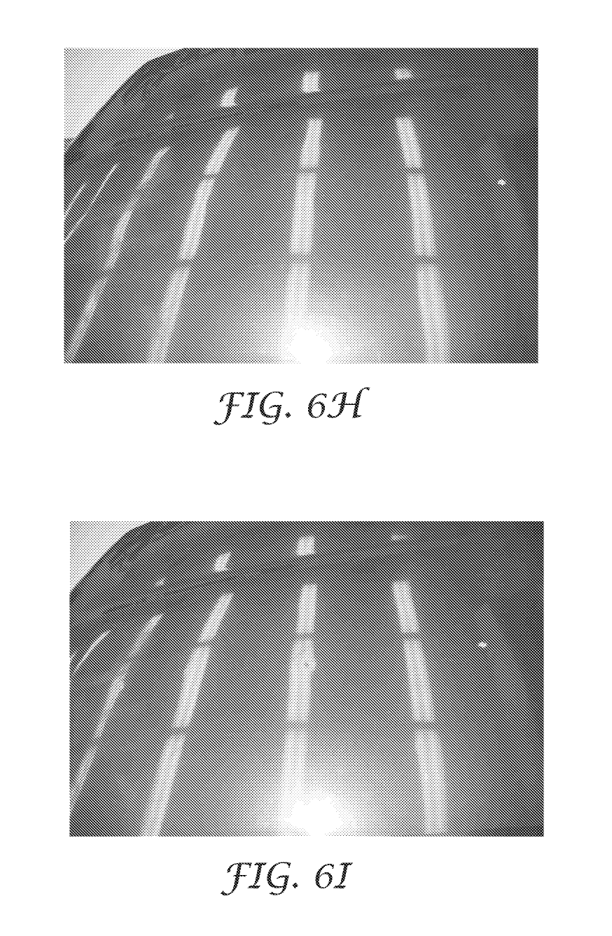

The damaged dark blue-green vehicle hood was then positioned approximately horizontally under the 4 by 6 array of Comparative observation lights at a distance of approximately 2.5 meters. Again, the ability to observe one or more of the damaged areas was dependent on the observer's position relative to the reflection of the overhead fluorescent lights, as demonstrated by FIGS. 6a 6i.

### EXAMPLE 3

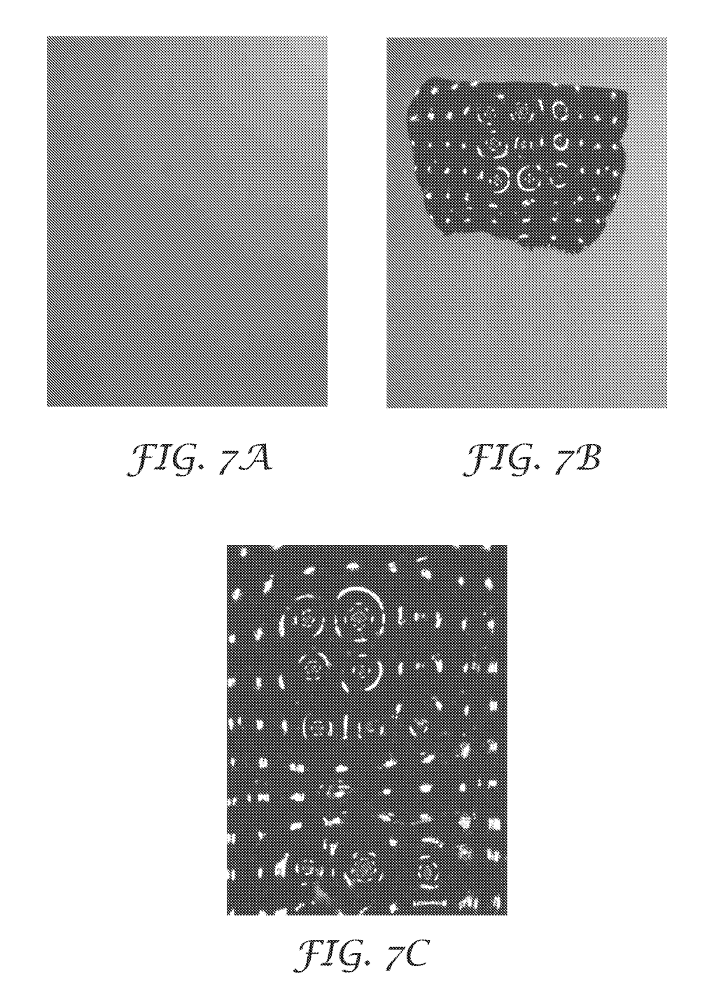

An automotive steel test panel having a prime coat, black base coat and a clear coat, Item No. 55875, obtained from ACT Test Panels, LLC, Hillsdale, Mich., was sanded to a matte finish using a random orbital sander and a fine abrasive disc, obtained under the trade designation “TRIZACT 471LA P1500” from 3M Company. The panel was then cleaned with water and a soft paper towel and dried. Two sets of 9 dents, each set in a 3 by 3 pattern, and each dent approximately 3 cm apart, were stamped in the matte test panel. The two sets of dent patterns were approximately 7.5 cm apart. The large array damage assessment light was obliquely positioned approximately 1.2 meters from the panel and illuminated. Due to the matte finish, no discrete LED's were observed reflecting off the damaged panel (FIG. 7a). In order to impart a reflective surface, a thin film of isopropanol was applied to a portion of the damaged panel by means of a buffing pad, obtained under the trade designation “Finesse-it Buffing Pad, Part No. 02648” from 3M Company. As demonstrated in FIG. 7b, the damage assessment light of the present invention clearly identifies the dent array. When the remainder of the matte panel was made reflective with a film of isopropanol, both sets of dents are clearly visible (FIG. 7c).

### EXAMPLE 4

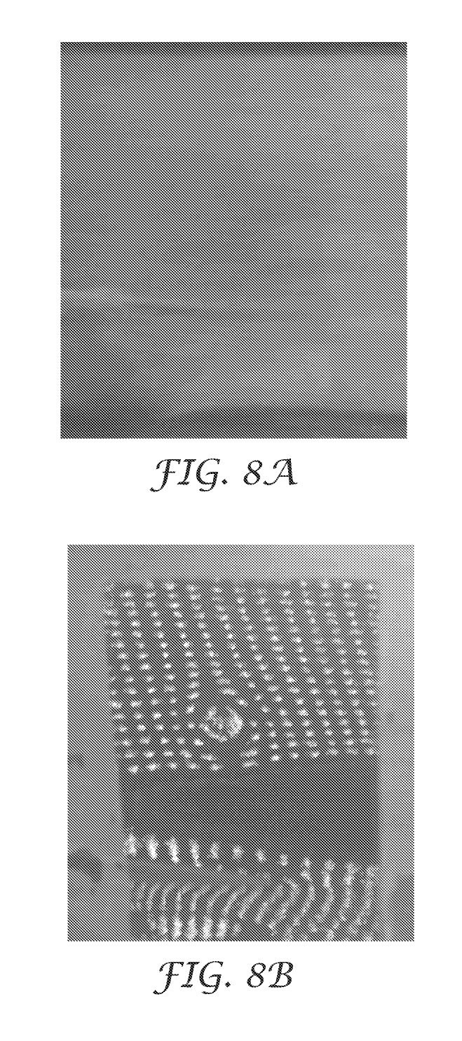

A dent was stamped into a section of an unpainted matte vehicle bumper. Illumination using the large array damage assessment light failed to identify the damaged area (FIG. 8a). The bumper was wetted with a diluted automotive shampoo, wiped with a squeegee, and a section of glossy, clear film, obtained under the trade designation “Paint Protection Film” from 3M Company, was applied of the dented area. The large array damage assessment light was obliquely positioned approximately 1.2 meters from the bumper. As shown in FIG. 8b, the dented area is identified by the reflection of discrete LED's forming a concentric ring pattern.

### EXAMPLE 5

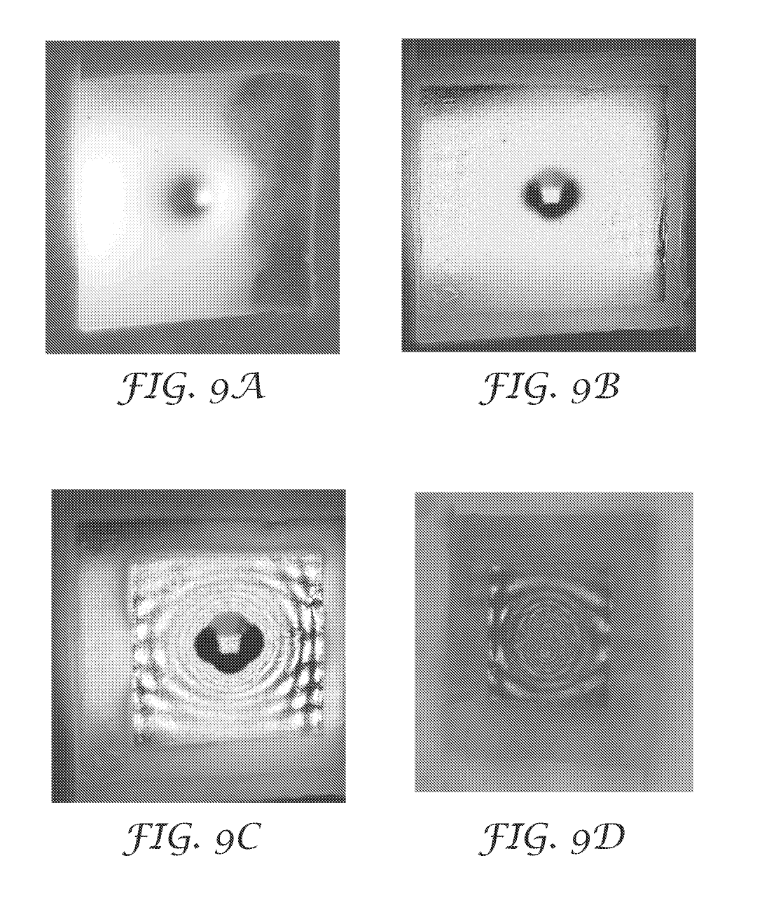

Two coats of black primer, obtained under the trade designation “RUST-OLEUM AUTOMOTIVE PRIMER” from Rust-Oleum Corporation, Vernon Hills, Ill., were sprayed on the uncoated, e-primed, side of an aluminum test panel, obtained from ACT Test Panels, LLC. After drying for 24 hours at 21° C., a dent was stamped into the prime coated panel. A 15 by 15 cm area covering the dent was masked with black polyethylene film, but did not reflect the LED's of the small array damage assessment light. The black polyethylene film was removed and three successive applications of clear coat, obtained under the trade designation “RUST-OLEUM PAINTER'S TOUCH ULTRA COVER” from Rust-Oleum Corporation, were then sprayed over the dented area of the panel. The clear coat was allowed to dry between each application, and the successive thickness of each clear coat measured using a model “POSITECTOR 6000 COATING THICKNESS GAUGE”, obtained from DeFelsko Corporation, Ogdensburg, N.Y. Under both the large and small array assessment lights, the dented area became more visible as the gloss of the panel surface increased. FIGS. 9a-9c illustrate the dented area illuminated with the small array damage assessment light at a distance of approximately one meter with the first, second and third clear coat applications, respectively. FIG. 9d shows the reflected LED pattern of the large inspection light at a distance of about 0.75 meters after the third clear coat. The cumulative thickness of the successive clear coats was approximately 30, 80 and 120 μm, respectively.

### Reflective Panels

### EXAMPLE 6

A reflective panel was made using a white-painted reflective automobile test panel for the background and a template was used in conjunction with a black-colored permanent marker to apply dots in a pattern to the panel.

Another reflective panel was made using a black-painted reflective automobile test panel for the background and a permanent white marker was used to apply dots in to the panel. A series of reflective panels were made using a white-painted reflective automobile test panel for the background and dots cut from various 3M colored tapes (black, yellow, red, blue, and green) having varying contrast to the panel.

Another reflective panel was made using magnetic dots made from plastic magnets affixed to a reflective transparent polyethylene terephthalate (PET).

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

1. A method of assessing topography of a reflective surface, the method comprising:
directing an arrayed light source onto the reflective surface to produce a reflected light pattern; and
observing the reflected light pattern without the use of a computer to detect the presence of one or more topographical features of the reflective surface.

2. The method of claim 1 wherein the arrayed light source comprises a plurality of point sources that generate an initial light pattern comprising pattern elements, wherein the reflected light pattern comprises the initial light pattern as altered by the presence of one or more topographical features of the reflective surface.

3. The method of claim 2 further comprising passing light from the plurality of point sources through a lens to shape the light to generate the pattern elements of the initial light pattern.

4. The method of claim 1 wherein the arrayed light source comprises a patterned mask and an off-apparatus light source and the method further comprising positioning the patterned mask in between the off-apparatus light source and the reflective surface, the patterned mask filtering light from the off-apparatus light source to generate the pattern elements of the initial light pattern.

5. The method of claim 1 wherein the arrayed light source comprises a panel having one or more reflective portions and an off-apparatus light source and the method further comprising locating the panel such that light from the off-apparatus light source reflects off the panel to generate the pattern elements of the initial light pattern.

6. The method of claim 2 wherein the pattern elements comprise a repeating pattern of points of light.

7. The method of claim 2 wherein the initial light pattern comprises a grid of light, the pattern elements comprising line segments in the grid.

8. The method of claim 2 wherein the pattern elements are dispersed in both an X direction and a Y direction.

9. The method of claim 2 wherein the pattern elements are equally spaced along the X direction and/or the Y direction.

10. The method of claim 7 wherein the initial light pattern comprises a grid of light, the pattern elements comprising line segments in the grid, the grid comprising a first set of parallel line segments and a second set of parallel line segments, the first set of parallel line segments being angularly offset from the second set of parallel line segments by a first angle.

11. The method of claim 10 wherein the first angle is in a range from 85 degrees to 95 degrees.

12. The method of claim 1 comprising recording the reflected light pattern with an image recording device.

13. The method of claim 1, wherein the reflective surface comprises a work surface treated to enhance its reflectivity.

14. The method of any claim 1 comprising marking the one or more topographical features after receiving the reflected light pattern.

15. The method of claim 2 wherein the initial light pattern comprises pattern elements of a first color and pattern elements of a second color that differs in average wavelength from the first color by at least 25 nm.

16. The method of claim 2 wherein the array of point sources is disposed on a light panel, wherein directing the initial light pattern comprises adjusting the position of the light panel to direct the initial light pattern onto a desired portion of the work surface.

17. The method of claim 4 wherein the patterned mask is disposed on a light panel, wherein directing the initial light pattern comprises adjusting the position of the light panel to direct the initial light pattern onto a desired portion of the work surface.

18. The method of claim 1 wherein the arrayed light source illuminates an area of the reflective surface that is at least 8 ft² (7,432 cm²).

19. The method of claim 18, wherein the area is at least 12 ft² (11,148 cm²).

20. The method of claim 19, wherein the area is at least 16 ft² (14,864 cm²).

21. The method of claim 20, wherein the area is at least 24 ft² (22,296 cm²).

22. The method of claim 2 wherein the point sources comprise a plurality of light emitting diodes (LEDs) arranged in a grid pattern.

23. The method of claim 1 wherein the observing step comprises visually detecting a swirl in the reflected light pattern in the presence of the one or more topographical features.

24. The method of claim 2 further comprising passing light from the plurality of point sources through a transmissive layer to generate the pattern elements of the initial light pattern.

25. An apparatus for assessing topography of a reflective surface, the apparatus comprising:
an arrayed light source to illuminate the reflective surface thereby producing a reflected light pattern; and
a portable support operatively connected to the arrayed light source by an adjusting element;
wherein the reflected light pattern is effective to convey the presence of one or more topographical features of the reflective surface to an observer without the use of a computer.

26. The apparatus of claim 25, wherein the portable support comprises:
a frame; and
a panel adjustably mounted to the frame and comprising a plurality of point sources disposed that generate an initial light pattern comprising pattern elements from the panel, wherein the point sources are dispersed over an area of the panel that is at least 12 ft² (11,148 cm²).

27. The apparatus of claim 26, wherein the panel is adjustably mounted to the frame by the adjusting element comprising an adjusting element axis, the panel being rotatable about the adjusting element axis to a first panel angular position and a second panel angular position.

28. The apparatus of claim 26 wherein the panel is adjustably mounted to the frame by a riser element comprising a riser axis, the panel being adjustable along the riser axis to varying panel heights.

29. The apparatus of claim 26 wherein the frame comprises one or more motion elements that permit the apparatus to be moved from a first shop position to a second shop position.

30. The apparatus of claim 29 wherein the one or more motion elements is selected from the group consisting of casters, rails, carriages, sliders, and combinations thereof

31. The apparatus of claim 26 comprising a lens positioned adjacent the plurality of point sources to shape the light to generate the pattern elements of the initial light pattern.

32. The apparatus of claim 25 wherein the arrayed light source comprises a patterned mask and an off-apparatus light source, the patterned mask filtering light from the off-apparatus light source to generate the pattern elements of the initial light pattern.

33. The apparatus of claim 25 wherein the arrayed light source comprises a panel having one or more reflective portions and an off-apparatus light wherein light from the off-apparatus light source reflects off the panel to generate the pattern elements of the initial light pattern.

34. The apparatus of claim 26 wherein the pattern elements comprise a repeating pattern of points of light.

35. The apparatus of claim 26 wherein the initial light pattern comprises a grid of light, the pattern elements comprising line segments in the grid.

36. The apparatus of claim 26 wherein the pattern elements are dispersed in both an X direction and a Y direction.

37. The apparatus of claim 36 wherein the pattern elements are equally spaced along the X direction and/or the Y direction.

38. The apparatus of claim 35 wherein the initial light pattern comprises a grid of light, the pattern elements comprising line segments in the grid, the grid comprising a first set of parallel line segments and a second set of parallel line segments, the first set of parallel line segments being angularly offset from the second set of parallel line segments by a first angle.

39. The apparatus of claim 38 wherein the first angle is in a range from 85 degrees to 95 degrees.

40. The apparatus of claim 25 comprising an image recording device positioned to receive and record receiving a reflected light pattern that comprises the initial pattern as altered by reflecting from the work surface.

41. The apparatus of claim 40 comprising an image processor adapted to assess the reflected light pattern to detect the presence of a first topographical feature on the work surface.

42. The apparatus of claim 40 wherein the image recording device is attached to one of the frame or the panel.

43. The apparatus of claim 40 wherein the image recording device is remote from the frame and the panel.

44. The apparatus of claim 26 wherein the initial light pattern comprises pattern elements of a first color and pattern elements of a second color that differs in average wavelength from the first color by at least 25 nm.

45. The apparatus of claim 26 wherein the point sources comprise a plurality of light emitting diodes (LEDs) arranged in a grid pattern.

46. The apparatus of claim 25 wherein the reflected light pattern comprises a swirl in the presence of the one or more topographical features.
